(19) United States
(12) Patent Application Publication
(10) Pub. No.: US 2007/0071877 A1
(43) Pub. Date: Mar. 29, 2007

(54) Novel frankfurter configuration

(76) Inventor: Moshe Dear, Brooklyn, NY (US)

Correspondence Address: BERNARD MALINA, MALINA & ASSOCIATES, P.C.;Suite 501, 60 East 42nd Street, New York, NY, 10165, US

(21) Appl. No.: 11/238,008

(22) Filed: Sep. 28, 2005

(51) Int. Cl. A23L 1/31

(52) U.S. Cl. 426/641

(57) ABSTRACT

A frankfurter has a non-circular cross-section which may be triangular, square or rectangular. In the event that the frankfurter is improperly swallowed, air spaces are formed between the straight walls of the frankfurter and the circular wall of the esophagus. The air spaces allow the passage of air thereby preventing choking and facilitate removal by medical personnel.

### BACKGROUND OF THE INVENTION

It has been found that the ingestion of frankfurters by small children can be hazardous due to the cylindrical configuration of this product. Thus, if a small child swallows a piece of frankfurter, there is a danger of choking because the circular cross-section closely conforms to the circular cross section of the esophagus and occupies the entire cross section of a small child's esophagus.

The prior art related to specially shaped food products includes the following U.S. Patents.

U.S. Pat. No. 6,767,567 B1 to Phillippa Donaire covers an Indigestible Element which has the form of a short cylindrical member which has a pair of cross-drilled holes. The holes are intended to provide air passageways and prevent choking in the event that the item is swallowed the wrong way.

U.S. Pat. No. D489,865 S to Stefano Pavan shows a Snack in the form of an elongated tubular member. The outer surface of the member has hexagonal sides and the member has a longitudinal circular aperture.

U.S. Pat. No. D492,467 S to Bruce T. Pittard, et al. for a Helical Food Product shows an elongated food member with a cruciform cross-section. The food member is twisted along a longitudinal axis thereby forming a helical configuration.

U.S. Pat. No. Des 94,174 to C. H. Vogt for an Encased Meat Loaf shows a meat loaf which has the form of a triangular prism.

U.S. Pat. No. 2,937,095 to A. Zitin for a Food Product and Method of Making the Same shows an elongated cylindrical food member. The food member has a central aperture having a star-shaped cross-section.

U.S. Pat. No. Des. 254,396 to Arthur W. Carlson for a Flat Frankfurter shows an elongated flat food member. The food member has a plurality of transversely oriented indentations.

U.S. Pat. No. Des. 337,643 to George T. Betz, Jr. for a Spiral Slit Frankfurter shows an elongated food member in which a V-shaped spiral has been cut. The V-shaped spiral forms a thread-like structure while maintaining the generally cylindrical configuration of the outer surface of the member.

U.S. Pat. No. Des. 392,435 to Gerardas Johannes Mocking for a Tubular Food Product shows an elongated food member which has a generally square or prismoidal cross-section. The food member has a longitudinal central aperture which is also square or prismoidal in configuration thereby forming a flat walled tubular member.

U.S. Pat. No. Des. 401,735 to Jeffrey A. Rom for a Pretzel Wrapped Hot Dog Food Product shows a cylindrical hot dog first food member onto which a second elongated cylindrical food member has been spirally wound. The second food member forms the configuration of a closely wound spring which encases the first food member.

U.S. Pat. No. 6,054,152 to Terry N. Blount, et al. for an Anti-Choking Candy Design shows a spherical candy member. The spherical candy member includes three cross-drilled mutually intersecting cylindrical holes which provide air passageways to prevent choking.

U.S. Pat. No. D437,101 S to Amnar Debbonz for Pasta shows an elongated pasta food member which has a generally cruciform cross-section. The outer ends of the arms of the cruciform are rounded. Adjacent arms of the food member form a V-shaped longitudinal indentation.

Despite the developments of the prior art, there remains a need for a frankfurter configuration which will prevent the danger of choking by small children which currently results from the conventional frankfurter lodging in the child's esophagus and preventing proper air flow.

### OBJECTS AND SUMMARY OF THE INVENTION

It is an object of the present invention to provide a novel frankfurter configuration which prevents choking even when lodged in a child's throat.

Another object of the present invention is to provide a novel frankfurter configuration which has a generally triangular cross-section.

Another object of the present invention is to provide a novel frankfurter configuration which has a generally square cross-section.

Another object of the present invention is to provide a novel frankfurter configuration which has a generally rectangular cross-section.

Another object of the present invention is to provide a novel frankfurter configuration which has a non-circular cross-section.

Another object of the present invention is to provide a novel frankfurter configuration which has a generally straight-sided cross-section.

Yet another object of the present invention is to provide a novel frankfurter configuration which can be manufactured, in volume, using conventional frankfurter manufacturing equipment resulting in a low unit cost.

The foregoing and other objects and advantages of the invention will appear more clearly hereinafter.

In accordance with the present invention there is provided a frankfurter which is formed to have a triangular cross section rather than the conventional circular cross section. In this manner, gaps will remain between the sides of the triangular cross section frankfurter and the surrounding circular cross section of the esophagus walls. In an alternate embodiment, the frankfurter may have a square cross section which, for the above reasons, provides a smaller but still effective gap between the sides of the frankfurter and the walls of the esophagus.

Additional alternative embodiments of the invention include frankfurters which have rectangular cross-section and other non-circular cross-sectional configurations.

### DESCRIPTION OF THE DRAWINGS

Other important objects and advantages of the invention will be apparent from the following detailed description taken in connection with accompanying drawings in which:

FIG. 1 shows an overall perspective view of a novel frankfurter configuration made in accordance with the present invention;

FIG. 2 is a cross-section view taken along the line 2-2 of FIG. 1 showing a generally triangular cross-section;

FIG. 3 is a schematic view of the frankfurter of FIG. 1 showing the frankfurter lodged in the esophagus of a child;

FIG. 4 shows a perspective view of an alternative embodiment of the invention;

FIG. 5 shows a perspective view of another alternative embodiment of the invention;

FIG. 6 shows a perspective view of yet another alternative view of yet another alternative embodiment of the invention;

FIG. 7 is a cross-sectional view taken along the line 7-7 of FIG. 4;

FIG. 8 is a cross-sectional view taken along the line 8-8 of FIG. 5;

FIG. 9 is a cross-sectional view taken along the line 9-9 of FIG. 6;

FIG. 10 is an end view of an extrusion tool used in the manufacture of the frankfurter of FIG. 1;

FIG. 11 is an end view of an extrusion tool used in the manufacture of the frankfurter of FIG. 4.

FIG. 12 is an end view of an extrusion tool used in the manufacture of the frankfurter of FIG. 8;

FIG. 13 is an end view of an extrusion tool used in the manufacture of the frankfurter of FIG. 9;

FIG. 14 is an end view of another alternative embodiment of the invention;

FIG. 15 is an end view of an extrusion tool used in the manufacture of the frankfurter of FIG. 14;

FIG. 16 is an end view of another alternate embodiment of the invention; and

FIG. 17 is an end view of an extrusion tool used in the manufacture of the frankfurter of FIG. 16.

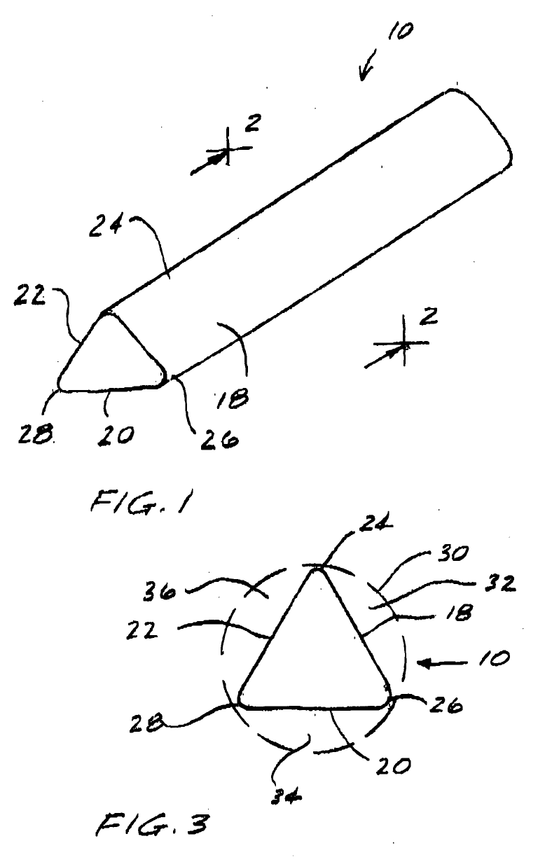

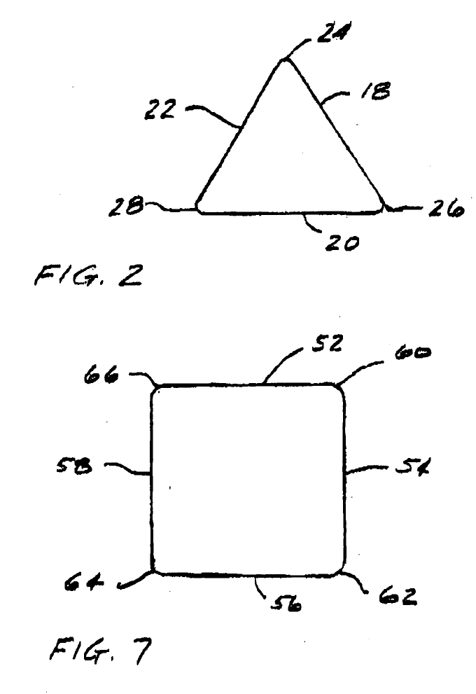

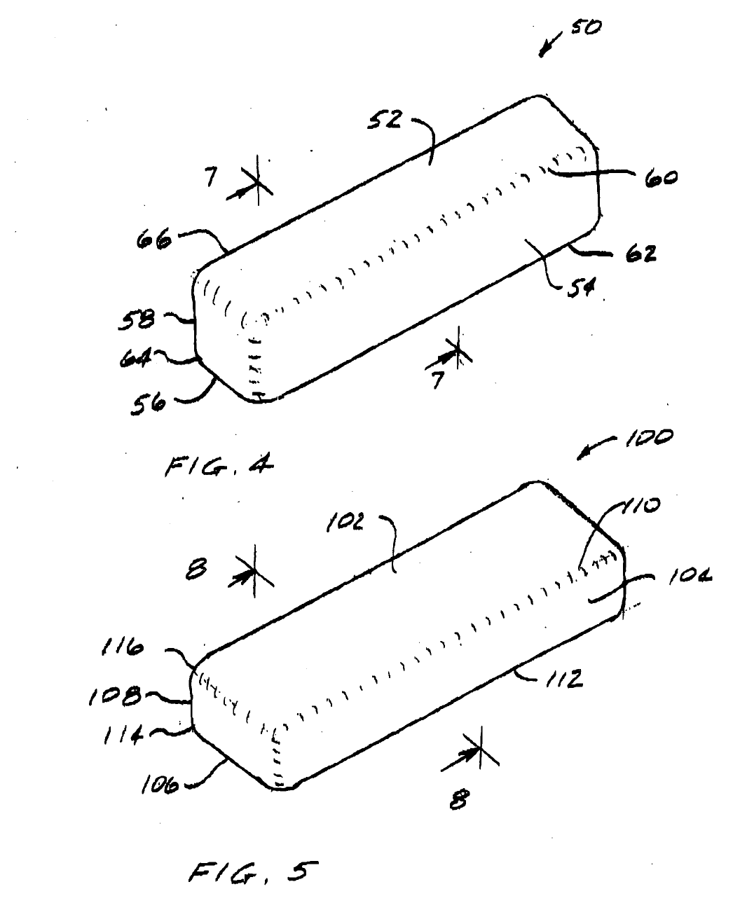

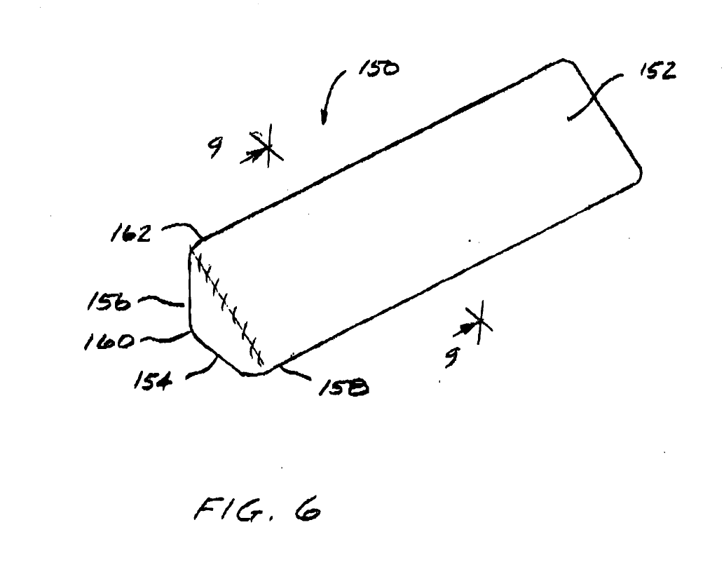

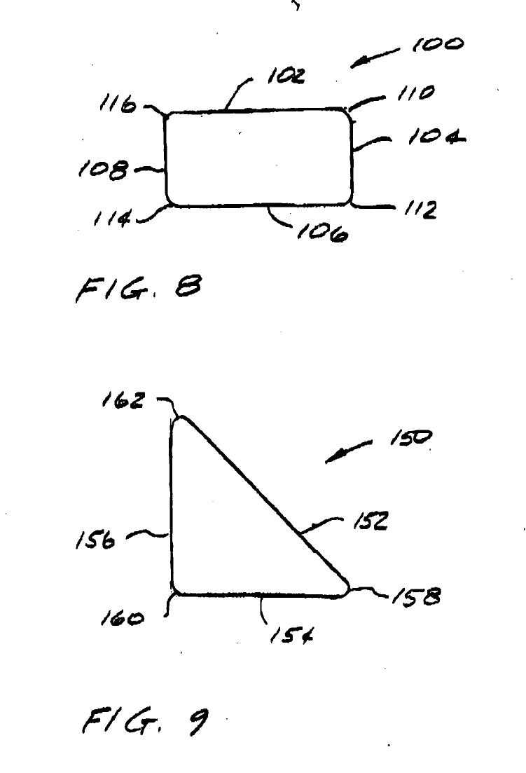

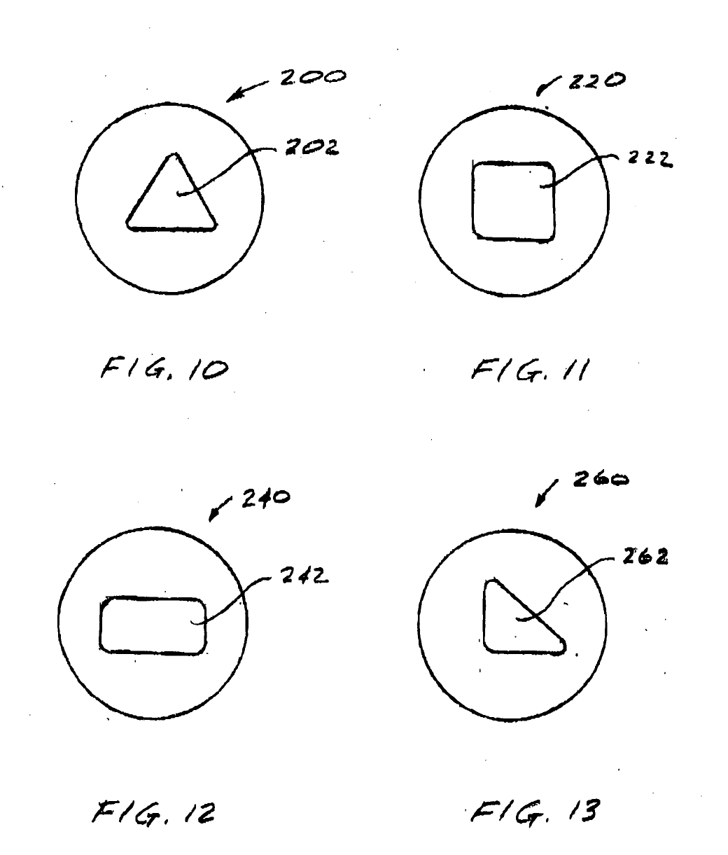

With reference to the drawings wherein like reference numbers designate like or corresponding parts throughout, there is shown in FIG. 1 a novel frankfurter 10 configuration made according to the present invention which has the overall form of an elongated member 12 having ends 14, 16 and which includes three generally flat surfaces 18, 20, 22. As is shown in FIG. 2, adjacent flat surfaces 18 and 22, 18 and 20, 20 and 22 are joined by curved surfaces 24, 26, 28 respectively, thereby forming a generally triangular cross-section.

As is best shown in FIG. 3 in which the esophagus is indicated schematically in broken lines 30, the flat surfaces which form a non-circular cross-section and provide a key feature of the present invention. In the event that a portion of the frankfurter according to the present invention is swallowed incorrectly and becomes lodged in the esophagus 30, the flat surfaces 18, 20, 22 do not conform to the curved wall of the esophagus 30, thereby providing air passageways 32, 34, 36 between the flat surfaces 18, 20, 22 of the frankfurter 10 and the curved wall 30 of the esophagus.

These air passageways 32, 34, 36 enable a child or an adult who has improperly swallowed the frankfurter 10 to receive air to his or her lungs and provides time for first aid and medical personnel to remove the frankfurter. In addition, because the frankfurter 10 makes only local contact with the wall 30 of the esophagus along the curved wall portions 24, 26, 28 as shown in FIG. 3, the ability of the esophagus 30 to retain the frankfurter 10 is limited thereby facilitating removal of first aid and medical personnel.

In contrast to the present invention, the circular cross-section of conventional frankfurters (which has not been illustrated) can easily make an air-tight seal against the circular wall 30 of the esophagus resulting in choking. Even if first aid or medical personnel immediately attempt to remove a conventional frankfurter from a choking patient, the close fit between the cylindrical surface of a conventional frankfurter and the circular wall 30 of the esophagus creates a sealing relationship making timely removal of a conventional frankfurter extremely difficult.

FIGS. 4-6, 14 and 16 show alternative embodiments of the invention all of which incorporate the key features of a non-circular cross-section which is formed by generally flat wall surfaces.

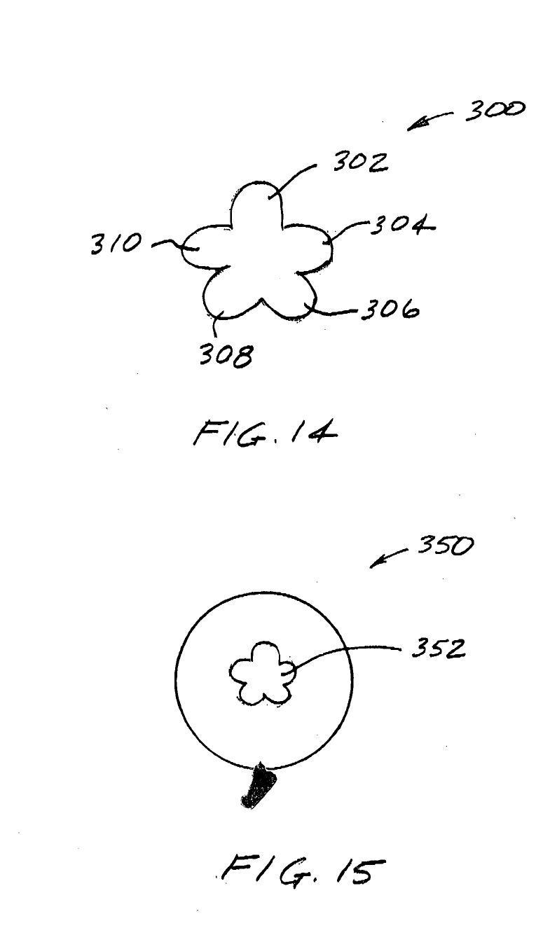

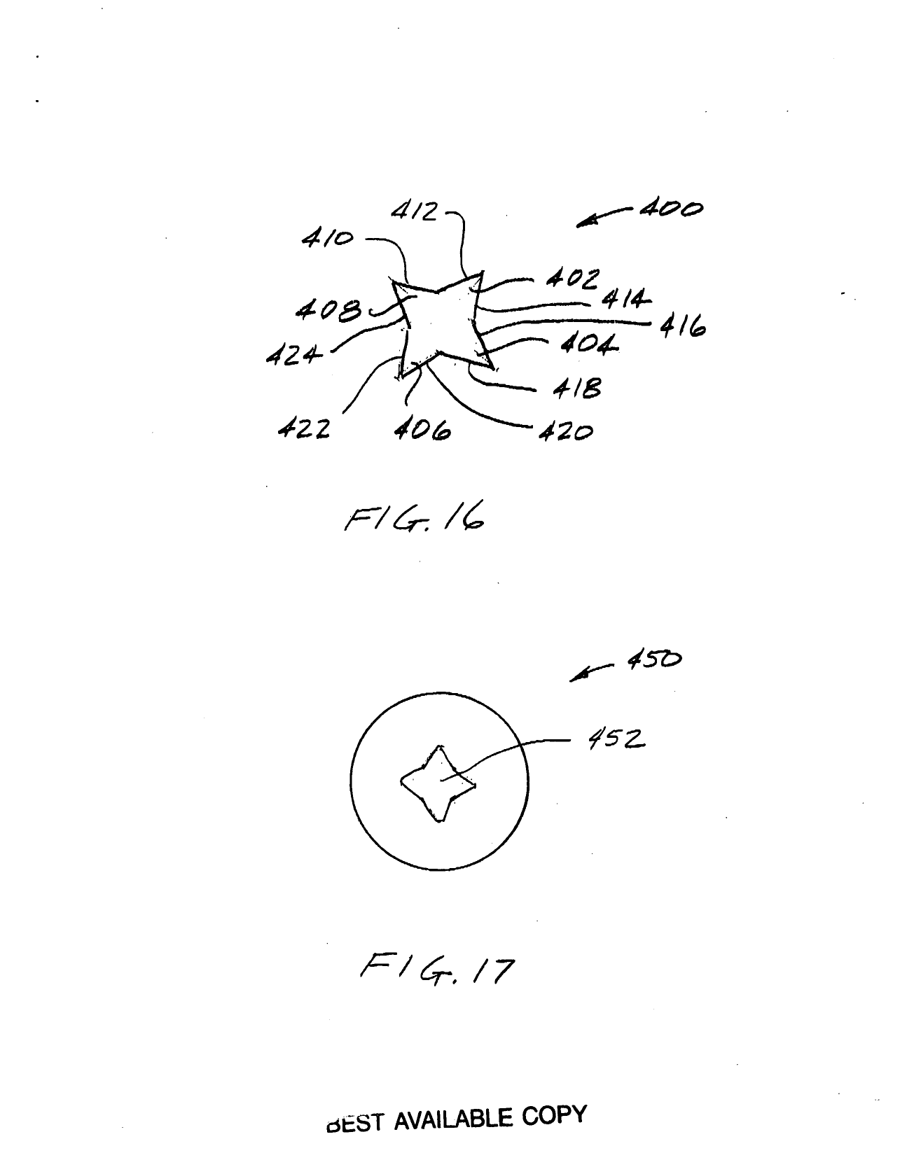

FIG. 4 shows an alternative embodiment of the invention in which the frankfurter 50 includes four flat surfaces 52, 54, 56, 58 thereby forming a generally square cross-section which is shown in FIG. 7.

Adjacent flat surfaces 52 and 54, 54 and 56, 56 and 58, 58 and 52, are joined by curved walls 60, 62, 64, 66 respectively.

FIG. 5 shows another alternative embodiment of the invention in which the frankfurter 100 includes four flat surfaces 102, 104, 106, 108 thereby forming a generally rectangular cross-section.

Adjacent flat surfaces 102 and 104, 104 and 106, 106 and 108, 108 and 102 are joined by curved walls 110, 112, 114, 116 respectively.

FIG. 14 shows another alternative embodiment of the invention in which the frankfurter 300 has a multi-lobed or star-shaped configuration. The frankfurter includes rounded lobes 302, 304, 306, 308, 310.

FIG. 16 shows another alternative embodiment of the invention in which the frankfurter 400 has a star-shaped configuration. The frankfurter includes lobes 402, 404, 406, 408 which have straight sides 410, 412, 414, 416, 418, 420, 422, 424.

The frankfurters 10, 50, 100, 150, 300 according to the present invention are manufactured using processing steps which include the steps of preparing the frankfurter food stuff material adding desired flavorings and spices followed by grinding mixing.

The novel cross-sectional configuration of the frankfurter 10, 50, 100, 150, 300 according to the present invention is accomplished by forcing the frankfurter foodstuff material through the novel frankfurter extrusion tools 200, 220, 240, 260, 350 shown in FIGS. 10-13 and 15.

FIGS. 10-13, 15 and 17 show schematic views of the extrusion tools 200, 220, 240, 260, 350, 450 used during the manufacture of the frankfurter 10, 50, 100, 150, 300, 400 according to the present invention. FIG. 10 shows the extrusion tool 200 used to manufacture the frankfurter 10 of FIG. 1 while FIGS. 11-13, 15 and 17 show the extrusion tools 220, 240, 260, 350, 450 used to manufacture the frankfurters 50, 100, 150 of FIGS. 4, 5, 6, 14 and 16 respectively.

Each of the extrusion tools 200, 220, 240, 260, 350 and 450 includes an aperture 202, 232, 242, 262, 352, 452 shaped in accordance with the cross-section of the frankfurter 10, 50, 100, 150, 300, 400.

The frankfurters 10, 50, 100, 150, 300, 400 may include casings or alternatively, the frankfurters 10, 50, 100, 150, 300, 400 may be skinless.

The foregoing specific embodiments of the present invention as set forth in the specification herein are for illustrative purposes only. Various deviations and modifications may be made within the spirit and scope of this invention, without departing from a main theme thereof.

What is claimed is:

1. A frankfurter comprising an elongated member having a non-circular cross-section.

2. The frankfurter as claimed in claim 1 wherein the cross-section of said elongated member is generally triangular.

3. The frankfurter as claimed in claim 1 wherein said cross-section of said elongated member comprises at least one flat side.

4. The frankfurter as claimed in claim 1 wherein said cross-section of said elongated member comprises a plurality of straight sides.

5. The frankfurter as claimed in claim 1 wherein said cross-section of said elongated member is generally rectangular.

6. The frankfurter as claimed in claim 2 wherein said generally triangular cross-section comprises three generally straight side wall portions and three curved wall portions disposed one each between adjacent straight side wall portions.

7. A method for manufacturing a frankfurter comprising the step of forcing frankfurter foodstuff material through an extrusion tool having a non-circular aperture.

8. The method for manufacturing frankfurters as claimed in claim 7 wherein said step of forcing frankfurter foodstuff through an extrusion tool comprises forcing said foodstuff through an extrusion tool having a generally triangular aperture.

9. The method for manufacturing frankfurters as claimed in claim 7 wherein said step of forcing said frankfurter foodstuff through an extrusion tool comprises forcing said foodstuff through an extrusion tool having a generally rectangular aperture.

10. The method for manufacturing frankfurters as claimed in claim 7 wherein said step of forcing said frankfurter foodstuff through an extrusion tool comprises forcing said foodstuff through an extrusion tool having a generally square aperture.

11. The method for manufacturing frankfurters as claimed in claim 7 wherein said step of forcing said frankfurter foodstuff through an extrusion tool comprises forcing said foodstuff through an extrusion tool having a generally straight-sided aperture.

12. The frankfurter as claimed in claim 1 wherein the cross-section of said elongated member is generally star-shaped.

13. The method for manufacturing frankfurters as claimed in claim 7 wherein said step of forcing said frankfurter foodstuff through an extrusion tool comprises forcing said foodstuff through an extrusion tool having a generally star-shaped aperture.
